(19) United States
(12) Patent Application Publication
(10) Pub. No.: US 2018/0146647 A1
(43) Pub. Date: May 31, 2018

(54) MEDETOMIDINE FOR USE IN CONTROLLING PARASITIC CRUSTACEANS ON FISH

(71) Applicant: I-Tech AB, Mölndal (SE)

(72) Inventors: Dan Isaksson, Mölndal (SE); Lena Mårtensson Lindblad, Hovås (SE)

(21) Appl. No.: 15/571,648

(22) PCT Filed: May 6, 2016
(86) PCT No.: PCT/EP2016/060195

§ 371 Date: Nov. 3, 2017

Related U.S. Application Data
(60) Provisional application No. 62/157,498, filed on May 6, 2015.

(51) Int. Cl. A01K 61/13; A01K 63/04; A01N 43/50

(52) U.S. Cl. CPC A01K 61/13; A01N 43/50; A01K 63/04

(57) ABSTRACT

Medetomidine or a salt thereof for use in controlling parasitic crustaceans, such as sea lice, on fish, e.g. salmon. A method of improving water flow into and out of a cage or net for fish farming, by providing said cage or net with a surface coating containing medetomidine or a salt thereof in an amount effective to reduce biofouling of said cage or net. The coating is capable of releasing medetomidine or the salt thereof into the water in the cage or net in an amount effective to reduce or prevent parasitic infestation of the fish in the cage or net.

### FIELD OF THE INVENTION

The present invention relates to a new use for the anti-fouling agent medetomidine in marine environments.

### BACKGROUND OF THE INVENTION

Fish farming is a form of aquaculture, also called pisciculture, which utilizes enclosures such as ponds, cages or nets of various formats both in fresh-water, sea-water or brackish water, usually for food-fish production. The most common food-fish are carp, salmon and catfish.

Driven by a continuously higher demand for fish and fish protein, aquaculture nowadays represents a large part of seafood production (estimated approx. 40% in 2005) also mirrored by high economic impacts. Two types of fish aquaculture exist, extensive aquaculture (depends on local photosynthetic production) and intensive aquaculture (depends on external food supply). Off-shore cultivation involves submerged cages or nets that are placed at sea, with different geometries, consisting of a metal or plastic frame with mesh or net to contain the fish. It is highly important for the fish welfare to keep these nets clean so that they are not subjected to for example bio fouling, in order to sustain the flow of water and water circulation through the nets to provide fresh, clean, oxygenated water to the caged fish. Recent advances in cage construction have also involved the use of copper alloys in the nets to prevent biofouling, due to coppers antimicrobial/algaecidal and antifouling properties, and the copper alloy nets are also corrosion resistant. Copper alloys such as copper-zinc brass, copper nickel and copper-silicon are for example used.

Fish densities are kept high inside the cages, and such high densities make the fish prone to various types of disease, parasites and related stress factors compared to outside the nets. The fish therefore need monitoring and various types of treatments to keep healthy, through e.g. vaccinations and use of bactericides. Sea lice or parasitic crustaceans present one of the major threats besides infections of various types for fish farms with salmon for example, represented by mainly two Copepodae species, Lepeophtheirus (L. salmonis) and Caligus. Damage to the fish by these types of sea lice or parasites are found mainly on the scales, epithelium, mucose and in worse cases the dermis, which may also lead to secondary infections and ultimately death if the wounds are severe, thus leading to financial losses of the fish farm. L. salmonis exist in different larval stages, including the copepodid stage, which attach to the fish and then develop to adults through different stages.

Various ways have been developed to handle the parasites in fish farms, including the use of various pest control substances. However, some of these cause problems to the marine environment since they have to be used in high concentrations to be effective. Substances with low toxicity, higher degradability and no injury to marine life except sea lice are described in WO2011157733. Compositions of these types of substances may be added to the cages in the form of solutions, emulsions, suspensions, powders or tablets and the like. The fish may also be transferred and handled by various types of bath treatments, in order to treat, prevent and minimize the infestations of the parasites. Also, the treatment may involve the use of injectable formulations, and in may such cases with the purpose to vaccinate the fish against the parasites. This type of handling of fish can however be stressful and damaging to the fish as well, and in some cases also contributing to a loss in yield in the fish farms. The substances may also be given to the fish through their food (pellets etc.). There has also been some initial trial to utilize certain species of wrasses, to reduce the parasitic infestations of food-fish populations, mimicking and taking advantage of natural behavior of the wrasses to feed on the parasites of the host-fish.

### SUMMARY OF THE INVENTION

One aspect of the present invention is to use medetomidine as an agent for antifouling in marine environments, more specifically to reduce and prevent marine biofouling on the cages submersed in water utilized for fish farming, and thus subsequently improve the flow of water through the cages.

A related aspect of the invention is to reduce and prevent fish parasitic crustaceans including sea lice on the fish that is farmed inside the cages.

Another aspect of the invention relates to a coating or a paint comprising medetomidine, applied to cages for fish farming, whereby medetomidine slowly leaks from the coating or paint of the cage immersed in water, to reduce and prevent biofouling on the cages and also to reduce and prevent fish parasitic crustaceans including sea lice on the fish that is farmed inside the cages.

Another aspect of the invention is to provide an effective amount of the medetomidine to the cages via delivery systems, exemplified but not limited to solutions, emulsions, suspensions, powders, tablets and the like, or formulated and encapsulated in beads, capsules, gels and the like, to reduce and prevent fish parasitic crustaceans including sea lice on the fish that is farmed inside the cages.

Thus, medetomidine may be formulated and encapsulated in beads, capsules, gels and the then added to the cages or nets via water-permeable containers or bags and the like that are attached to lines that span the height of the cage or net and are distributed evenly over the volume of the cage or net. The medetomidine slowly leaks into the surrounding water. The lines are connected to a floating part, above the water, and a sinker or weight below the water. Such water-permeable containers or bags and the like that are attached to lines, containing medetomidine formulated and encapsulated in beads, capsules, gels and the like, are easily exchanged or replaced when the concentration of medetomidine is close to a minimum concentration, or e.g. at predetermined intervals.

### BRIEF DESCRIPTION OF THE DRAWINGS

FIG. 1 is a schematic representation of a delivery system of medetomidine.

FIG. 2A is a bar chart showing the motility of adult lice as events meaning the number of times the lice detached themselves from the petri dish surface over 10 min period. The y-axis is the difference between two measurements; before and after exposing the louse to medetomidine. N=2-3; mean±SEM. The significance was tested with one way Anova with Dunett's post hoc test. * p<0.05.

FIG. 2B is a bar chart showing the motility of pre-adult II lice as events meaning the number of times the lice detached themselves from the petri dish surface over 10 min period. The y-axis is the difference between two measurements; before and after exposing the louse to medetomidine. N=4; mean±SEM. The significance was tested with one way Anova with Dunett's post hoc test. ***p<0.001.

### DETAILED DESCRIPTION OF THE INVENTION

The foregoing and other aspects of the present invention will now be described in more detail with respect to the description and methodologies provided herein. It should be appreciated that the invention may be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention.

The skilled person will understand that terminology used in the description of the invention herein is for the purpose of describing particular embodiments only and is not intended to be limiting of the invention. Unless otherwise defined, all terms, including technical and scientific terms used in the description, have the same meaning as commonly understood by one of ordinary skill in the art to which this invention belongs.

As used in the description of the embodiments of the invention, the singular forms “a,” “an” and “the” are intended to include the plural forms as well, unless the context clearly indicates otherwise. Thus, such references may be replaced with a reference to “one or more” (e.g. one) of the relevant component or integer. As used herein, all references to “one or more” of a particular component or integer will be understood to refer to from one to a plurality (e.g. two, three or four) of such components or integers. It will be understood that references to “one or more” of a particular component or integer will include a particular reference to one such integer. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, refers to variations of 20%, 10%, 5%, 1%, 0.5%, or even 0.1% of the specified amount. When a range is employed (e.g., a range from x to y) it is it meant that the measurable value is a range from about x to about y, or any range or value therein including x and y, such as about x₁ to about y₁, etc. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof.

Unless otherwise defined, all terms, including technical and scientific terms used in the description, have the same meaning as commonly understood by one of ordinary skill in the art to which this invention belongs.

“Effective amount” as used herein refers to an amount of a compound, composition and/or formulation of the invention that is sufficient to produce a desired effect.

By the term “treat,” “treating,” or “treatment of” (and grammatical variations thereof) it is meant that the severity of the subject's condition is reduced, at least partially improved or ameliorated and/or that some alleviation, mitigation or decrease in symptom is achieved and/or there is a delay in the progression of the disease or disorder.

A “therapeutically effective” amount as used herein is an amount that is sufficient to treat (as defined herein) the subject. Those skilled in the art will appreciate that the therapeutic effects need not be complete or curative, as long as some benefit is provided to the subject. The term “therapeutically effective” as used herein in reference to an amount or dose refers to an amount of a compound, composition and/or formulation of the invention that is sufficient to produce a desired effect, which can be a therapeutic and/or beneficial effect.

As used herein the term “concomitant administration” or “combination administration” of a compound, therapeutic agent or known drug with a compound of the present invention means administration of a known medication or drug and, in addition, the one or more compounds of the invention at such time that both the known drug and the compound will have a therapeutic effect. In some cases this therapeutic effect will be synergistic. Such concomitant administration can involve concurrent (i.e., at the same time), prior, or subsequent administration of the known drug with respect to the administration of a compound of the present invention. A person skilled in the art will have no difficulty determining the appropriate timing, sequence and dosages of administration for particular drugs and compounds of the present invention.

In addition, in some embodiments, the compounds of this invention will be used, either alone or in combination with one or more other active ingredients as described herein.

Pharmaceutically acceptable salts include, but are not limited to, acid addition salts and base addition salts. Such salts may be formed by conventional means, for example by reaction of a free acid or a free base form of a compound of the invention with one or more equivalents of an appropriate acid or base, optionally in a solvent, or in a medium in which the salt is insoluble, followed by removal of said solvent, or said medium, using standard techniques (e.g. in vacuo or by freeze-drying). Salts may also be prepared by exchanging a counter-ion of a compound of the invention in the form of a salt with another counter-ion, for example, using a suitable ion exchange resin. For the avoidance of doubt, other pharmaceutically acceptable derivatives of compounds of the invention are included within the scope of the invention (e.g. solvates).

For the purpose of the present invention, “pharmaceutically acceptable” refers to acceptability for veterinary use, more particularly for use in the treatment of fish.

The term “biofouling” as used herein generally refers to the undesirable accumulation, adhesion, and growth of microorganisms, plants, algae, tubeworms, barnacles, mollusks, and other organisms, in particular barnacles, on a solid surface.

Compounds of the invention may exhibit tautomerism. All tautomeric forms and mixtures thereof are included within the scope of the invention.

Compounds of the invention also contain one or more asymmetric carbon atoms and may therefore exhibit optical and/or diastereoisomerism. Diastereoisomers may be separated using conventional techniques, e.g. chromatography or fractional crystallization. The various stereoisomers may be isolated by separation of a racemic or other mixture of the compounds using conventional, e.g. fractional crystallization or HPLC, techniques. Alternatively, the desired optical isomers may be made by reaction of the appropriate optically active starting materials under conditions which will not cause racemization or epimerization, or by derivatization, for example with a homochiral acid followed by separation of the diastereomeric derivatives by conventional means (e.g. HPLC, chromatography over silica). All stereoisomers are included within the scope of the invention.

All patents, patent applications and publications referred to herein are incorporated by reference in their entirety. In the event of conflicting terminology, the present specification is controlling. Further, the embodiments described in one aspect of the present invention are not limited to the aspect described. The embodiments may also be applied to a different aspect of the invention as long as the embodiments do not prevent these aspects of the invention from operating for their intended purpose.

Medetomidine or (±) 4-[1-(2, 3-Dimethylphenyl) ethyl]-1H-imidazole has proven to be an efficient inhibitor with regards to barnacle settlement, and bio fouling of surfaces in marine environments. The larval settlement of barnacles is impeded already at low concentrations of medetomidine, 1 nM to 10 nM. Medetomidine belongs to a new class of alpha2-receptor agonists containing a 4-substituted imidazole ring with, high selectivity towards 2-adrenoreceptors. Medetomidine, first described in EP 72615, is a racemic mixture of equal proportions of two optical enantiomers, the levo- and dextro-rotatory optical isomers (MacDonald et al., 1991; Savola and Virtanen, 1991) with generic names levomedetomidine and dexmedetomidine respectively. WO 2011/070069 discloses a process for the preparation of the racemic mixture of medetomidine and related intermediates. Many of the previous syntheses use expensive 4-substituted imidazole derivatives as starting material, however in WO 2011/070069 the synthesis is made from affordable commercially available starting materials, where the imidazole ring is instead built up during the synthesis.

Using the Cahn-Ingold-Prelog naming system, the two isomers are termed (R)-4-[1-(2,3-dimethylphenyl)ethyl]-1H-imidazole:

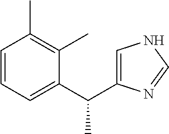

and (S)-4-[1-(2,3-dimethylphenyl)ethyl]-1H-imidazole:

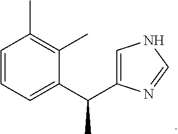

For the purpose of the present invention, the compound referred to as “medetomidine”, i.e. (±) 4-[1-(2, 3-dimethylphenyl) ethyl]-1H-imidazole or (R,S)-4-[1-(2, 3-dimethylphenyl) ethyl]-1H-imidazole may be either a mixture of the two isomers, in any proportion, e.g. a racemic mixture thereof, or may be any of the two isomers in essentially pure form. In some embodiments, use is made of a composition of the two isomers containing a major proportion of (R)-4-[1-(2,3-dimethylphenyl)ethyl]-1H-imidazole, e.g. more than 70%, or more than 80% or more than 90%, or more than 95% thereof. In some other embodiments, use is made of a composition of the two isomers containing a major proportion of (S)-4-[1-(2,3-dimethylphenyl)ethyl]-1H-imidazole, e.g. more than 70%, or more than 80% or more than 90%, or more than 95% thereof.

In some embodiments, medetomidine for use according to the present invention is (R)-4-[1-(2,3-dimethylphenyl)ethyl]-1H-imidazole. In some other embodiments, medetomidine for use according to the present invention is (S)-4-[1-(2,3-dimethylphenyl)ethyl]-1H-imidazole.

Furthermore, in some embodiments, any tautomer of (R)-4-[1-(2,3-dimethylphenyl)ethyl]-1H-imidazole also is comprised within the scope of the invention, e.g. (R,S)-4-[1-(2, 3-dimethylphenyl) ethyl]-3H-imidazole, or any of its optical isomers.

The α2-adrenoceptor agonist medetomidine is known to result in sedation and locomotor inhibition when given to mammals and fish (Sinclair, 2003; Ruuskanen et al., 2005). The opposite was found in cyprid larvae since medetomidine (10 nM) strongly enhanced kicking of the cyprid larvae, with more than 100 kicks per minute (Mol Pharmacol 78:237-248, 2010). Thus, medetomidine has different physiological effects in vertebrates and invertebrates; in the latter group it provokes hyperactivity, rather than sedation/locomotor inhibition as in vertebrates. Medetomidine induces a locomotor activation response in barnacle cyprids, which is the most likely cause of settling inhibition. More specifically the increase in the movement (kicking) of the anterior appendices (legs) is suggested to be the anti-settling mode of action of medetomidine.

For controlled release purposes, a combination of medetomidine and a polymer complex may be utilized, as additives to self-polishing paints (US2006223906 Method and use of acidified modified polymers to bind biocides in paints). In such cases the medetomidine is bound to a sulfonated, acid sulphate ester, phosphonic acid, carboxylic acid or acid phosphate ester modified polymer backbone such as polystyrene or acrylate polymers. In some aspects medetomidine bound to polystyrene-block-poly(ethylene-ran-butylene)-block-polystyrene will create a slow leakage of the active compound from the polymer-based paint into the water in a controlled fashion.

Controlled release may also involve nanoparticles of various types, including copper(II)- and zinc(II)oxide formulated into nanoparticle sizes (US 20060201379). Due to the large specific surface area (ratio between surface area and particle volume), the nanoparticles contribute to adsorb the antifouling agent, e.g. medetomidine, or other antifouling agents such as Chlorothalonil, Dichlofluanid, SEANINE™, IRGAROL™ DIURON™, and Tolyffluanid. The antifouling agent, e.g. medetomidine, bound to nanosized metal oxide is a compound that leaks out of the paint into water in a controlled fashion. The antifouling agent bound to nanosized metal oxide thus has excellent dispersion stability because of its large size, compared to the antifouling agent particle alone.

In some embodiments, medetomidine is used together with one or more other active ingredients, e.g. one or more anti-biofouling agents, such as algicides, herbicides, fungicides and/or one or more therapeutically active agents for veterinary use, e.g. for use in the treatment of fish, such as vaccines, antibiotics, anti-viral agents, anti-parasitic agents, e.g. one or more further compounds active against parasitic crustaceans, etc.

Medetomidine has a specific action on barnacle cyprids but no effect on algal growth due to the target protein being lacking within algae. There are several methods to prevent algal growth, among them the use of copper and other metals in fairly high concentrations or the use of certain algicides. Medetomidine may therefore be utilized in combination with algicides such as zinc- and copper pyrithion, fungicides like tolyfluanid and dichlofluanid, herbicides such as DIURON™ and IRGAROL™, or more general biocides such as SEANINE™ or ECONEA™ (2-(p-chlorophenyl)-3-cyano-4-bromo-5-trifluoromethyl) pyrrole by Janssen Pharmaceutical, Titusville, N.J., USA. Specific preferred algicides include copper, zinc and other metals, DIURON (3-(3,4-dichlorophenyl)-1,1-dimethylurea), IRGAROL 1051™ (2-methylthio-4-tert-butylamino-6-cyclopropylamino-s-triazine), zinc pyrithione (Zinc, bis(1-hydroxy-2(1H)-pyridinethionato-O,S)-, (T-4)-), copper pyrithione (Copper, bis(1-hydroxy-2(1H)-pyridinethionato-O,S)-, (T-4)-), diclofluanid (N′-dimethyl-N-phenylsulphamide), ZINEB™ (zinc ethylene bisdithiocarbamate), ZINRAM™ (Zinc bis(dimethylthiocarbamates)), maneb (manganese ethylene bisdithiocarbamate), quaternary ammonium compounds, SEANINE™ (4,5-dichloro-2-n-octyl-3(2H)-isothiazolone), and ECONEA™ (2-(p-chlorophenyl)-3-cyano-4-bromo-5-trifluoromethyl).

In some embodiments, medetomidine is used in combination with one or more other compound(s) known to be active against parasitic crustaceans (e.g. sea lice), e.g. one or more compounds selected from hydrogen peroxide, formaldehyde, trichlorfon, malathion dichlorvos, azamethiphos, ivermectin, emamectin benzoate, moxidectin, teflubenzuron diflubenzuron, hexaflumuron, lufenuron, fluazuron, cypermethrin c/s-40: trans-60, deltamethrin, high cis cypermethrin c/s-80: trans-20, imidacloprid, nitenpyram, thiamethoxam, thiacloprid, clothianidin, acetamiprid spinosad, epofenonane, triprene, methoprene, hydroprene, kinoprene, phenoxycarb. In some embodiments, the compound of the invention is combined with a compound selected from an organophosphate, a pyrethroid such as cypermethrin or deltamethrin, a macrocyclic lactone such as emamectin benzoate, hydrogen peroxide or a benzoylurea, such as diflubenzuron, lufenuron or hexaflumuron.

In one aspect, the present invention generally relates to the inhibition of marine biofouling of surfaces in marine environments, specifically to the use of medetomidine as an agent for prevention of marine bio fouling of solid surfaces, more specifically cages submersed in water utilized for fish farming. More specifically, the invention concerns the use of medetomidine as an antifouling component of coatings or paints for cages submersed in water utilized for fish farming, for the dual and/or combined purpose of reducing and preventing bio fouling of the cages submersed in water utilized for fish farming in order 1) to improve the flow of water through the nets of the cages and also 2) to prevent and reduce the fish parasitic crustaceans including sea lice on the fish that is farmed inside the cages.

In a related aspect of the invention, medetomidine is added to a marine paint for application to the nets or cages containing the food-fish in fish farms, specifically to reduce the settlement of barnacles to the cages or nest, thus reducing the biofouling of these cages or nets and improving the flow of water and water circulation through the nets or cages. In such a marine paint, medetomidine will be present at 0.01-2%, preferably 0.1-0.3%. In another related aspect of the invention, for improving the flow of water and water circulation through the nets or cages, such a marine paint may comprise the use of nanoparticles, including copper(II)- and zinc(II)oxide formulated into nanoparticle sizes, for controlled release purposes. Also, in a related aspect of the invention, for improving the flow of water and water circulation through the nets or cages, a combination of medetomidine and a polymer complex may be utilized, as additives to self-polishing paints, where the medetomidine is bound to a sulfonated, acid sulphate ester, phosphonic acid, carboxylic acid or acid phosphate ester modified polymer backbone such as polystyrene or acrylate polymers, including polystyrene-block-poly(ethylene-ran-butylene)-block-polystyrene for controlled release purposes. In another aspect of the invention, for improving the flow of water and water circulation through the nets or cages, medetomidine will be used in combination with algicides such as zinc- and copper pyrithion, fungicides like tolyfluanid and diclofluanid, herbicides such as DIURON™ and IRGAROL™, or more general biocides such as SEANINE™ or ECONEA™ (2-(p-chlorophenyl)-3-cyano-4-bromo-5-trifluoromethyl) by Janssen Pharmaceutical, Titusville, N.J., USA. Specific preferred algicides include copper, zinc and other metals, DIURON (3-(3,4-dichlorophenyl)-1,1-dimethylurea), IRGAROL 1051™ (2-methylthio-4-tert-butylamino-6-cyclopropylamino-s-triazine), zinc pyrithione (Zinc, bis(1-hydroxy-2(1H)-pyridinethionato-O,S)-, (T-4)-), copper pyrithione (Copper, bis(1-hydroxy-2(1H)-pyridinethionato-O,S)-, (T-4)-), diclofluanid (N′-dimethyl-N-phenylsulphamide), ZINEB™ (zinc ethylene bisdithiocarbamate), ZINRAM™ (Zinc bis(dimethylthiocarbamates)), maneb (manganese ethylene bisdithiocarbamate), quaternary ammonium compounds, SEANINE™ (4,5-dichloro-2-n-octyl-3(2H)-isothiazolone), and ECONEA™ (2-(p-chlorophenyl)-3-cyano-4-bromo-5-trifluoromethyl).

Fish densities inside the cages or nets for fish farming are kept high, and the fish are therefore more prone to various types of parasites, infections and disease. In one aspect of the invention medetomidine is specifically used to reduce, prevent and treat parasitic infestations of parasitic crustaceans, such as sea lice, exemplified but not limited to Lepeophtheirus (L. salmonis) inside the cages or nets of fish farms.

In a related aspect of the invention, medetomidine is added to a marine paint for application to the nets or cages containing the food-fish in fish farms, where the medetomidine leaks out into the water to reduce, prevent and treat parasitic infestations of parasitic crustaceans, such as sea lice, exemplified but not limited to Lepeophtheirus (L. salmonis), inside the cages or nets of fish farms. In another related aspect of the invention, where the medetomidine leaks out into the water to reduce, prevent and treat parasitic infestations of parasitic crustaceans, such as sea lice, exemplified but not limited to Lepeophtheirus (L. salmonis), such a marine paint may comprise the use of nanoparticles, including copper(II)- and zinc(II)oxide formulated into nanoparticle sizes, for controlled release purposes. Also, in a related aspect of the invention, where the medetomidine leaks out into the water to reduce, prevent and treat parasitic infestations of parasitic crustaceans, such as sea lice, exemplified but not limited to Lepeophtheirus (L. salmonis), a combination of medetomidine and a polymer complex may be utilized, as additives to self-polishing paints, where the medetomidine is bound to a sulfonated, acid sulphate ester, phosphonic acid, carboxylic acid or acid phosphate ester modified polymer backbone such as polystyrene or acrylate polymers, including polystyrene-block-poly(ethylene-ran-butylene)-block-polystyrene for controlled release purposes. In another aspect of the invention, where the medetomidine leaks out into the water to reduce, prevent and treat parasitic infestations of parasitic crustaceans, such as sea lice, exemplified but not limited to Lepeophtheirus (L. salmonis), medetomidine will be used in combination with algicides such as zinc- and copper pyrithion, fungicides like tolyfluanid and diclofluanid, herbicides such as DIURON™ and IRGAROL™, or more general biocides such as SEANINE™ or ECONEA™ (2-(p-chlorophenyl)-3-cyano-4-bromo-5-trifluoromethyl) by Janssen Pharmaceutical, Titusville, N.J., USA. Specific preferred algicides include copper, zinc and other metals, DIURON (3-(3,4-dichlorophenyl)-1,1-dimethylurea), IRGAROL 1051™ (2-methylthio-4-tert-butylamino-6-cyclopropylamino-s-triazine), zinc pyrithione (Zinc, bis(1-hydroxy-2(1H)-pyridinethionato-O,S)-, (T-4)-), copper pyrithione (Copper, bis(1-hydroxy-2(1H)-pyridinethionato-O,S)-, (T-4)-), diclofluanid (N′-dimethyl-N-phenylsulphamide), ZINEB™ (zinc ethylene bisdithiocarbamate), ZINRAM™ (Zinc bis(dimethylthiocarbamates)), maneb (manganese ethylene bisdithiocarbamate), quaternary ammonium compounds, SEANINE™ (4,5-dichloro-2-n-octyl-3(2H)-isothiazolone), and ECONEA™ (2-(p-chlorophenyl)-3-cyano-4-bromo-5-trifluoromethyl).

In such a marine paint, medetomidine will be present at 0.01-2%, preferably 0.1-0.3%, thus creating an effective concentration in the water inside the cages or nets containing the food-fish to reduce, prevent and treat parasitic infestations of parasitic crustaceans, such as sea lice, exemplified but not limited to Lepeophtheirus (L. salmonis).

In another aspect of the invention, medetomidine is added to a marine paint for application to the nets or cages containing the food-fish in fish farms, specifically with the dual and/or combined purposes to:

1) reduce the settlement of barnacles to the cages or nest, thus reducing the bio fouling of these cages or nets and improving the flow of water and water circulation through the nets or cages and/or
2) reduce, prevent and treat parasitic infestations of parasitic crustaceans, such as sea lice, exemplified but not limited to Lepeophtheirus (L. salmonis) inside the cages or nets of fish farms.

In some embodiments, the fish are present in a container, such as a cage or net, said container having openings allowing water to enter and exit the container and medetomidine is brought into contact with the surface of the container so as to allow for a reduction of bio fouling of the container surface at least in the vicinity of the openings. For example, medetomidine may be present in the water inside the container or in a coating applied to the container at least in the vicinity of the openings.

In some embodiments, a method is provided for improving or maintaining a flow of water through openings of a container for fish, such as a cage, net or similar confinement, or an aquarium, or tank, by bringing at least part of the surface (e.g. the inside walls) of the container into contact with medetomidine, e.g. dissolved in the water inside the container or applied in a coating on at least part of the surface of the container, preferably close to the openings for water flowing into and out of the container.

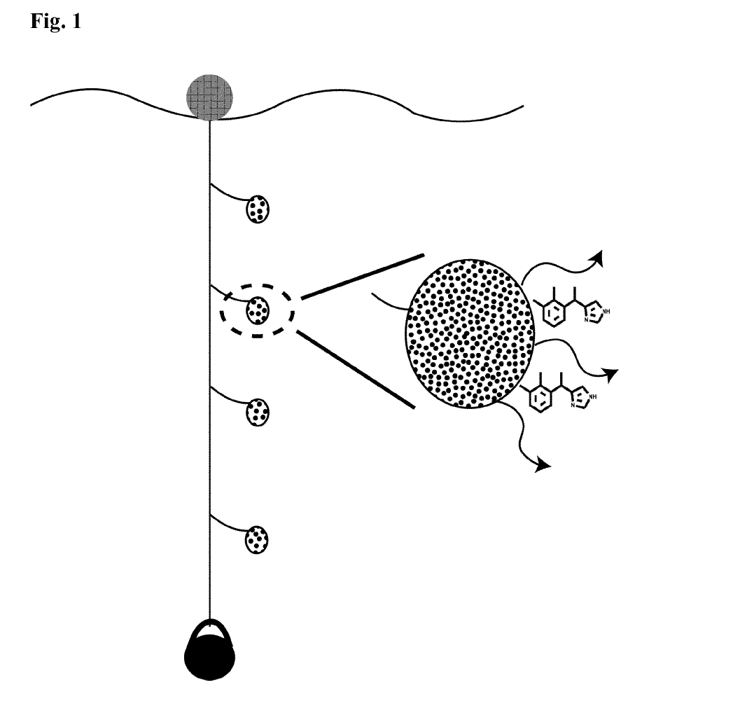

In a related aspect of the invention, an effective amount of the medetomidine is delivered to the cages via delivery systems, exemplified but not limited to solutions, emulsions, suspensions, powders, tablets and the like, or formulated and encapsulated in beads, capsules, gels and the like, to reduce and prevent fish parasitic crustaceans, such as sea lice, on the fish that are farmed inside the cages. Such delivery system will be able to continuously distribute an effective amount of medetomidine at a controlled rate inside the cages or nets. In a related aspect of the invention such solutions, emulsions, suspensions, powders, tablets of medetomidine and the like, or medetomidine formulated and encapsulated in beads, capsules, gels and the like are added to the cages or nets via the inlet or tube or similar that is used for providing the food supply to the fish kept in the cages or nets. In another aspect of the invention, medetomidine formulated and encapsulated in beads, capsules, gels and the like are added to the cages or nets via water-permeable containers or bags and the like that are attached to lines that span the height of the cage or net and are distributed evenly over the volume of the cage or net. Such water-permeable containers or bags and the like that are attached to lines, containing medetomidine formulated and encapsulated in beads, capsules, gels and the like, which are easily exchanged or replaced when the concentration of medetomidine is close to a minimum concentration or at timed intervals. FIG. 1 provides a schematic illustration of one embodiment of a delivery system according to the invention.

The concentration of medetomidine inside an enclosure for fish, e.g. a cage or net, should preferably be between 1 nanogram/liter (0.005 nM) to 100 microgram/liter (500 nM), e.g. from 20 nanogram/liter (0.1 nM) to 80 microgram/liter (400 nM), or from 100 nanogram/liter (0.5 nM) to 40 microgram/liter (200 nM), and more preferably between 200 nanogram/liter (1 nM) to 20 microgram/liter (100 nM).

In some embodiments, medetomidine or a salt thereof is released into water, e.g. from a prolonged release formulation in a container or bag, in vicinity to a source of light, e.g. an underwater solar lamp or an underwater LED lamp.

For example, in some embodiments any parts of the lines connecting to the floating part or the floating part itself connected to the sinker or weight below the surface water, can be associated with a light source in order to attract parasitic crustaceans that are photo tactic, e.g. salmon lice. By locating the medetomidine dosing apparatus in vicinity to the light source, the photo tactic parasite, attracted by and striving towards the light source, will come into vicinity of the dosing apparatus, where the concentration of medetomidine in the water may be expected to be the highest, which will increase the anti-parasitic efficacity.

Medetomidine or a salt thereof is suitably used in the control of various fish-parasitic crustaceans. Using generally accepted taxonomic classification, the parasitic organisms more particularly belong to the subphylum “Crustacea”, the class “Maxillopoda”, the subclass “Copepoda” and the order “Siphonostomatoida”, and to various families within this order, e.g. to the following families: Caligidae, Cecropidae, Dichelesthiidae, Lernaeopodidae, Pandaridae, Pennellidae, Sphyriidae, Lernaeidae, Bomolochidae, Chondracanthidae, Philichthyidae, and Ergasilidae.

Thus, the fish-parasitic crustaceans may be selected from the family Caligidae with representative genus Dissonus, Caligus (i.e. C. curtus, C. elongatus, C. clemensi, C. rogercresseyii), and Lepeophtheirus (i.e. L. salmonis); Families Cecropidae, Dichelesthiidae, Lernaeopodidae with representative genus Salmincola; Families Pandaridae, Pennellidae with representative genus Lernaeocera and Pennella; and Family Sphyriidae; Family Lemaeidae with representative genus Lernaea; Families Bomolochidae, Chondracanthidae, Ergasilidae and Philichthyidae.

In some embodiments, the fish-parasitic crustaceans are selected from the family Caligidae. In some embodiments, the fish-parasitic crustaceans are selected from the family Caligidae and from the genuses Caligus and Lepeophtheirus. In some embodiments, the fish-parasitic crustaceans are selected from the family Caligidae and from the genus Caligus. In some other embodiments the fish-parasitic crustaceans are selected from the family Caligidae and from the genus Lepeophtheirus. For example, the fish-parasitic crustaceans may be selected from C. curtus, C. elongatus, C. clemensi, C. rogercresseyii, and L. salmonis.

It should be realized that any fish susceptible to infestation by a fish-parasitic crustacean as mentioned herein above may be treated according to the invention. Such fish include food fish, breeding fish, and aquarium, pond, river, and reservoir fish of all ages occurring in freshwater, sea water and brackish water. Examples of fish that may be treated according to the invention include, but are not limited to, bass, bream, carp, catfish, char, chub, cichlid, cod, eel, flounder, gourami, grayling, grouper, halibut, mullet, plaice, pompano, roach, rudd, salmon, sole, tilapia, trout, whitefish, and yellowtail.

In some embodiments, the fish are food fish or breeding fish, in particular food fish. In some embodiments, the fish are aquarium fish. In some embodiments, the fish are fish in a container, such as a net or cage, e.g. in a fish farm.

In some embodiments, the fish belong to the family Salmonidae, especially of the subfamily salmoninae, and preferably, the Atlantic salmon (Salmon salar), rainbow trout (Oncorhynchus mykiss), brown or sea trout (S. trutta), the Pacific salmon: Cherry salmon or seema (O. masou), Taiwanese salmon (O. masou formosanum), Chinook salmon or King salmon (O. tshawytscha), chum salmon or Calico salmon (O. keta), coho salmon or silver salmon (O. kisutch), pink salmon (O. gorbuscha), Sockeye salmon or Red salmon (O. nerka), artifically propagated species, such as Salmo clarkii, and Salvelinus species such as Brook trout (S. fontinalis).

In some particular embodiments, the fish are selected from Atlantic and Pacific salmon and the sea trout.

The antiparasitic compositions of this invention normally comprise 0.1 to 100%, preferably 0.1 to 95%, of medetomidine and 1 to 99.9%, preferably 5 to 99.9%,—at least—of a solid or liquid adjuvant, 0 to 25%, preferably 0.1 to 20%, of the composition preferably being surfactants (%=percent by weight). While concentrated compositions are sometimes preferred as commercial goods, the end user, e.g. for bath application, normally uses compositions which are diluted with water and which have a substantially lower active substance content.

For example, in case of a bath treatment a concentration of from 0.001 to 50 ppm (by weight), preferably 0.005 to 20 ppm and in particular 0.005 to 10 ppm, based on the entire bath, of medetomidine may be used. In addition, the concentration of medetomidine during application depends on the manner and duration of treatment and also on the age and condition of the fish so treated. A typical bath treatment time is from 15 minutes to 4 hours, in particular from 30 minutes to 1 hour. The bath can contain further adjuvants, such as stabilizers, antifoams, viscosity regulators, binders, tackifiers as well as other active substances for achieving special effects. Preferred compositions to be added to the bath are, in particular, composed as follows: (%=percent by weight, based on the entire formulation).

### EXAMPLES

### Salmon Lice Test Protocol

### Test Subjects

Each day fresh animals newly picked from infected salmons were received. The lice were stored in a cooler until used. The lice were categorised as either adults or pre-adults stage II. The adults were both males and females with paired egg strings but most of the collected lice were pre-adults stage II.

### Procedure

The experiments were performed in Petri dishes filled with 20 ml of sea water. In experiments using adult lice, 5-8 lice were added to a dish and with pre adults II, 10-15 lice per dish were used. Each experiment was performed in pair; one dish as a control and the other treated with medetomidine. Before the start of the treatment, both dishes were filmed with a camera for one minute. After the film capture, 200 μL of medetomidine solution (E) was added to the test dish and thereafter incubated in the cooler for two hours. After two hours of incubation, the lice were returned to the lab bench and once more, the activity of the lice was captured over 1 minute. Thereafter, the motility of the lice was registered. As the lice prefer to be attached to the surface of the dish, it was possible to count the number of times when the individual louse de-attached from the surface. One de-attachment was noted as one event and reflected the motility of the lice. The number of events, as described above, was calculated over a 10-minute period. 200 μL of the second test solution (C) was added to the test dish and the dishes were returned to the cooler and the above described procedure was repeated. Each concentration (0, 1 or 100 nM) tested had an individual control.

Domitor solution, 1 mg/ml, was used in the experiment, 1 ml of which contains: 1.0 mg medetomidine hydrochloride, 1.0 mg methylparaben (NF), 0.2 mg propylparaben (NF), 9.0 mg sodium chloride (USP), and water for injection (USP), q.s.

The following solutions and concentrations (in moles/1) of medetomidine were prepared by diluting the Domitor solution:

| | Concentration of | Concentration in |
|---|---|---|
| Solution | solution [M] | petri dish [M] |
| Control | — | 0 |
| A | 10⁻³ | 10⁻⁵ |
| B | 10⁻⁴ | 10⁻⁶ |
| C | 10⁻⁵ | 10⁻⁷ |
| D | 10⁻⁶ | 10⁻⁸ |
| E | 10⁻⁷ | 10⁻⁹ |
| F | 10⁻⁸ | 10⁻¹⁰ |

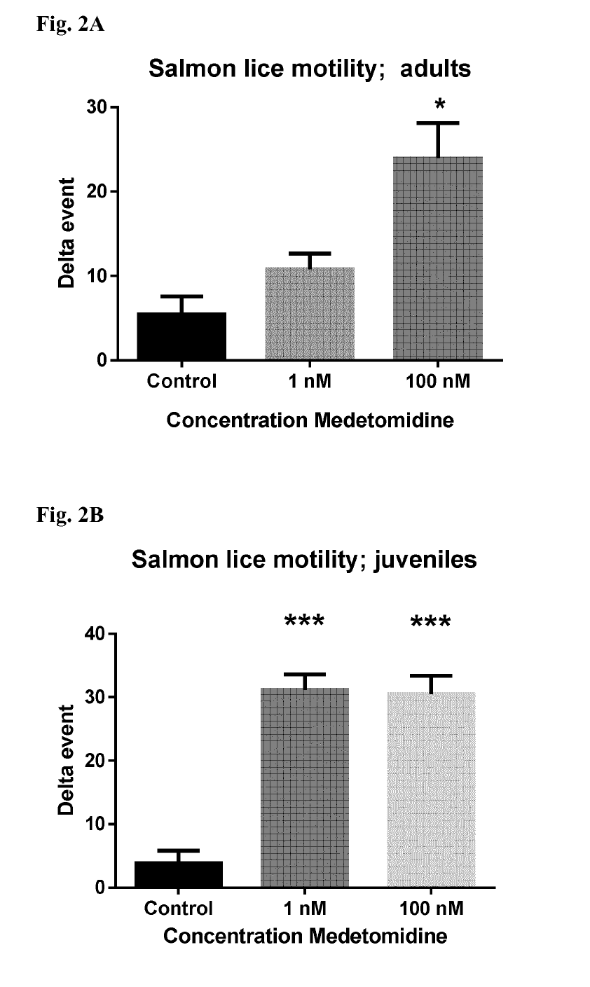

The test results are represented in FIGS. 2A and 2B.

1.-20. (canceled)

21. A method for the treatment of parasitic crustaceans on fish comprising bringing the fish into contact with medetomidine or a salt thereof.

22. A method of improving water quality in an enclosure for fish, by providing said enclosure with a surface coating containing medetomidine or a salt thereof in an amount effective to reduce biofouling of said enclosure.

23. The method according to claim 22, wherein the surface coating is capable of releasing medetomidine or the salt thereof into water in the enclosure in an amount effective to reduce or prevent parasitic infestation of fish in the enclosure.

24. The method according to claim 22, wherein the enclosure is a net or a cage for fish farming.
